(19) United States
(12) Patent Application Publication
(10) Pub. No.: US 2026/0238837 A1
(43) Pub. Date: Aug. 13, 2026

(54) MULTI-REGION LIVE STREAMING PIPELINES WITH STORAGE PROPAGATION

(71) Applicant: NETFLIX, INC., Los Gatos, CA (US)

(72) Inventors: Xiaomei LIU, Cupertino, CA (US); Rajasekhar UMMADISETTY, North Bend, WA (US)

(21) Appl. No.: 19/408,201

(22) Filed: Dec. 3, 2025

Related U.S. Application Data
(60) Provisional application No. 63/757,741, filed on Feb. 12, 2025.

(51) Int. Cl. H04N 21/2187; H04N 21/231

(52) U.S. Cl. CPC H04N 21/2187; H04N 21/23116

(57) ABSTRACT

One embodiment sets forth a method for streaming media content to endpoint devices. According to some embodiments, the method can include asynchronously replicating a plurality of packaged artifacts among a plurality of pipelines such that, for each pipeline included in the plurality of pipelines, a corresponding local datastore stores both locally generated packaged artifacts and remotely generated packaged artifacts; and, in response to receiving a request from an endpoint device for a packaged artifact included in the plurality of packaged artifacts: selecting, according to a global priority order, a candidate pipeline from among the plurality of pipelines, retrieving, from a local datastore, the packaged artifact associated with the candidate pipeline, and providing the packaged artifact to the endpoint device.

### CROSS-REFERENCE TO RELATED APPLICATIONS

This application claims the benefit of U.S. Provisional Application titled “TECHNIQUES FOR IMPLEMENTING LIVE STREAMING MULTI-REGION PIPELINES WITH STORAGE PROPAGATION” filed on Feb. 12, 2025, and having Serial No. 63/757,741. The subject matter of this related application is hereby incorporated herein by reference.

### BACKGROUND

### Field of the Invention

Embodiments of the present disclosure relate generally to computer science and streaming and video processing technologies and, more specifically, to multi-region live streaming pipelines with storage propagation.

### Description of the Related Art

Live streaming platforms deliver live content across multiple geographical regions to ensure availability for client playback. Live streaming platforms include one or more live streaming pipelines that provide services to one or more regions. The pipelines include sequences of components that process and deliver live content, herein referred to as packaged artifacts, within the region. The components can include, for example, an encoder, a packager, a live origin, and a database management layer. In operation, if a pipeline within a region experiences a failure, then another pipeline – either from the same region or a different region – can deliver the packaged artifacts. Asynchronous propagation can be performed by the database management layer. Generally, client devices and content distribution networks (CDNs) access the packaged artifacts from the associated region most proximal to the client device, enabling live streaming without playback interruption.

Conventional multi-region live-content distribution arrangements often rely on mechanisms that deliver output from a packaging workflow to multiple regional systems and also propagate the same output through separate replication processes. Such arrangements can generate substantial redundancy when identical content artifacts are distributed and replicated across numerous regional components, which increases storage consumption and complicates management of duplicated data. The repeated distribution operations performed by packaging components can also impose significant processing demands, particularly as the number of regions grows, because multiple distribution paths must be maintained in parallel. As regional scale increases, the number of required distribution operations can rise at a substantial rate, which can limit the practical expansion of multi-region deployments due to escalating processor usage and replication-related inefficiencies.

As the foregoing illustrates, what is needed in the art are more effective techniques for implementing live streaming pipelines in multiple regions.

### SUMMARY OF THE EMBODIMENTS

One embodiment sets forth a method for streaming media content to endpoint devices. According to some embodiments, the method can include asynchronously replicating a plurality of packaged artifacts among a plurality of pipelines such that, for each pipeline included in the plurality of pipelines, a corresponding local datastore stores both locally generated packaged artifacts and remotely generated packaged artifacts; and, in response to receiving a request from an endpoint device for a packaged artifact included in the plurality of packaged artifacts: selecting, according to a global priority order, a candidate pipeline from among the plurality of pipelines, retrieving, from a local datastore, the packaged artifact associated with the candidate pipeline, and providing the packaged artifact to the endpoint device.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques reduce publishing complexity of the packager from O(N²) to O(N). Linear scalability of the packager facilitates implementation of the live streaming platform across multiple regions without imposing quadratic growth in publishing from the packager. Such features therefore improve overall platform scalability capabilities.

Another technical advantage of the disclosed techniques over the prior art is that the disclosed techniques eliminate overlapping redundancy and reduce computational strain on the packagers. In particular, by avoiding replication of packaged artifacts by the packager, the disclosed techniques prevent unnecessary generation of duplicate copies across the pipelines. Reduced duplication improves storage utilization by reducing redundant storage. Additionally, reduced publishing operations improve processing efficiency of the packager by minimizing the number of publishing tasks that the packager must execute. Such optimization frees system resources and increases system reliability during live streaming operations.

These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a network infrastructure used to distribute content to content servers and endpoint devices, according to various embodiments.

FIG. 2 is a more detailed conceptual illustration of the pipeline of FIG. 1, according to various embodiments.

FIG. 3 is an illustration of multiple pipelines with storage propagation, according to various embodiments

FIG. 4 illustrates a flow diagram of a method for generation and distribution of packaged artifacts within a pipeline, according to various embodiments.

FIG. 5 illustrates a flow diagram of a method for activation and subsequent delivery of packaged artifacts in a warm standby pipeline, according to various embodiments.

FIG. 6 is a more detailed illustration of a computing device that can implement the functionalities of any of the entities illustrated in FIG. 1, according to various embodiments.

### DETAILED DESCRIPTION

In the following description, numerous specific details are set forth to provide a more thorough understanding of the present disclosure. However, it will be apparent to one skilled in the art that the present disclosure may be practiced without one or more of these specific details.

Live streaming platforms deliver live content across multiple geographical regions to ensure availability for client playback. Live streaming platforms include one or more live streaming pipelines that provide services to one or more regions. The pipelines include sequences of components that process and deliver live content, herein referred to as packaged artifacts, within the region. The components can include, for example, an encoder, a packager, a live origin, and a database management layer. In operation, if a pipeline within a region experiences a failure, then another pipeline – either from the same region or a different region – can deliver the packaged artifacts. Asynchronous propagation can be performed by the database management layer. Conventional techniques for distributing live content involve the packager transmitting the packaged artifacts to each of the live origins located in each region, in a process known as dual publishing. Each of the live origins stores the packaged artifacts from all regions. The live origins enable playback continuity through the packaged artifacts from another pipeline if the packaged artifacts of a given pipeline become unavailable or corrupt. In parallel, datastore replication is performed using the database management layer.

Conventional techniques for distributing live content involve the packager transmitting the packaged artifacts to each of the live origins located in each region, in a process known as dual publishing. In such a manner, redundancy is achieved because multiple regions can provide identical versions of the packaged artifacts. Each of the live origins stores the packaged artifacts from all regions. The live origins enable playback continuity through the packaged artifacts from another pipeline if the packaged artifacts of a given pipeline become unavailable or corrupt. In parallel, datastore replication is performed using the database management layer, also referred to as a datastore. In such a configuration, the datastore asynchronously propagates each of the packaged artifacts packaged in the pipeline to additional pipelines. Both dual publishing and datastore replication ensure that the packaged artifacts generated within the pipeline are present in each pipeline and thus multiple regions, maintaining content availability across regions.

One drawback of the dual publishing technique is excessive redundancy. In particular, each packager transmits the packaged artifacts to multiple live origins in each pipeline. At the same time, datastore replication also asynchronously propagates the same packaged artifacts across the pipelines. Such a combination therefore results in unnecessary copies of identical packaged artifacts already existing due to dual publishing. Such redundancy consumes superfluous storage resources in the pipelines and introduces complexity in managing duplicate data.

Another drawback of conventional approaches is the high processor usage associated with the packagers. In particular, because each packager executes multiple publishing operations to deliver the packaged artifacts to all live origins, processing resources are strained. When additional regions are added, the number of publishing operations exhibits O(N²) complexity, because each packager must transmit to each live origin. The quadratic growth in the distribution of the packaged artifacts renders expansion beyond two regions impractical, as system resources become increasingly consumed by redundant transmissions and replication overhead.

To address these issues, live streaming pipelines operate within a given region. The pipelines include an encoder, a packager, a live origin, and a datastore. The encoder generates live video streams, and the packager transforms such live video streams into packaged artifacts. The packager transmits the packaged artifacts once to the live origin associated with the pipeline of the packager. The live origin holds the packaged artifacts and coordinates with the datastore for replication operations to other regions. The datastore executes asynchronous propagation of the packaged artifacts across pipelines. The live origin performs the selection of the pipeline for playback based on a global priority order. The global priority order identifies a designated pipeline for primary playback retrieval. If the designated pipeline does not provide packaged artifacts – or, if the packaged artifacts have defects – for a requested livestream segment, the live origin retrieves the packaged artifacts from an alternate pipeline identified by the global priority order. Candidate selection occurs on a per-segment basis, which enables playback continuity when a failure or delay occurs in the given pipeline.

At least one technical advantage of the disclosed techniques relative to the prior art is that the disclosed techniques reduce publishing complexity of the packager from O(N²) to O(N). Linear scalability of the packager facilitates the implementation of the live streaming platform across multiple regions without imposing quadratic growth in publishing from the packager. Such features therefore improve overall platform scalability capabilities.

Another technical advantage of the disclosed techniques over the prior art is that the disclosed techniques eliminate overlapping redundancy and reduce computational strain on the packagers. In particular, by not implementing replication of packaged artifacts by the packager, the disclosed techniques avoid the unnecessary creation of duplicate copies across the pipelines. Reduced duplication improves storage utilization by reducing redundant storage. Additionally, reduced publishing operations improve processing efficiency of the packager by minimizing the number of publishing tasks that the packager must execute. Such optimization frees system resources and increases system reliability during live streaming operations.

### System Overview

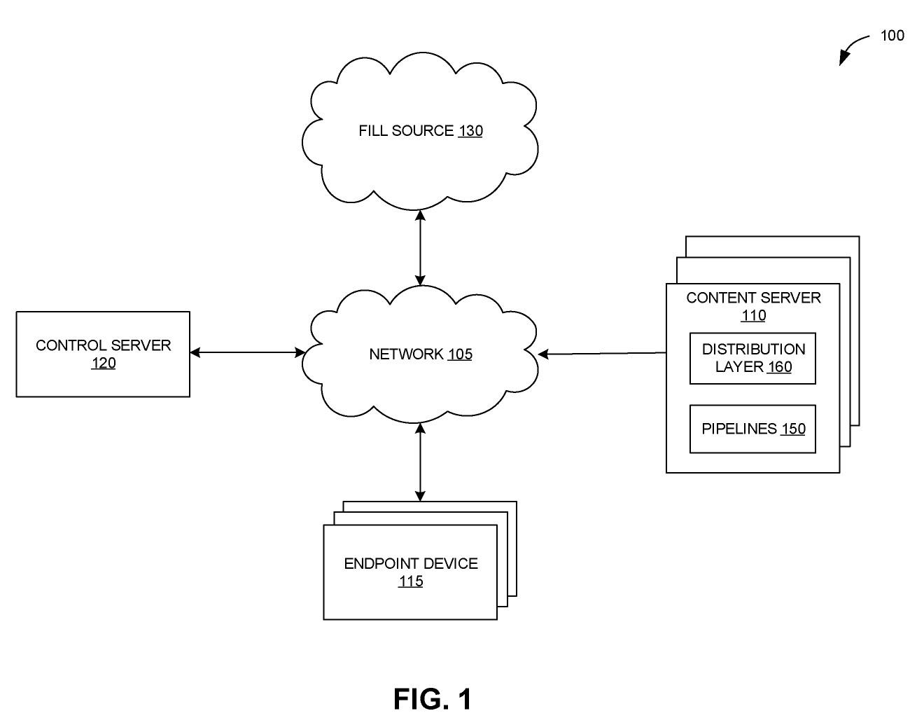

FIG. 1 illustrates a network infrastructure 100 used to distribute content (e.g., media segments or livestream segments) to content servers 110 and endpoint devices 115, according to various embodiments. As shown, the network infrastructure 100 includes content servers 110, a control server 120, fill sources 130, and endpoint devices 115, each of which is connected via a communications network 105.

As shown in FIG. 1, the content servers 110 implement a distribution layer 160 and pipelines 150. Each endpoint device 115 communicates with one or more content servers 110 (also referred to as “caches” or “nodes”) via the network 105 to download content such as textual data, graphical data, audio data, video data, and other types of data. The downloadable content, also referred to herein as a “file,” is then presented to a user of one or more endpoint devices 115. In various embodiments, the endpoint devices 115 may include computer systems, set-top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content such as text, images, video, and/or audio content to a user.

Each content server 110 may include a web server, database, and server application (not illustrated in FIG. 1) configured to communicate with the control server 120 to determine the location and availability of various files that are tracked and managed by the control server 120. Each content server 110 may further communicate with the fill sources 130 and one or more other content servers 110 to “fill” each content server 110 with copies of various files. In addition, content servers 110 may respond to requests for files received from endpoint devices 115. The files may then be distributed from the content servers 110 or via a broader content distribution network. In some embodiments, content servers 110 enable users to authenticate (e.g., using a username and password) to access files stored on content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed to fill the content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond fill source 130 to the extent desired or necessary.

Although FIG. 1 illustrates the pipelines 150 as being logically included in the content servers 110, it will be appreciated that the pipelines 150 can be implemented in other entities included in the network infrastructure 100, consistent with the scope of this disclosure. The pipelines 150 can also be distributed across multiple components such that different modules of the pipelines 150 operate on different components. Any such arrangement remains within the scope of this disclosure.

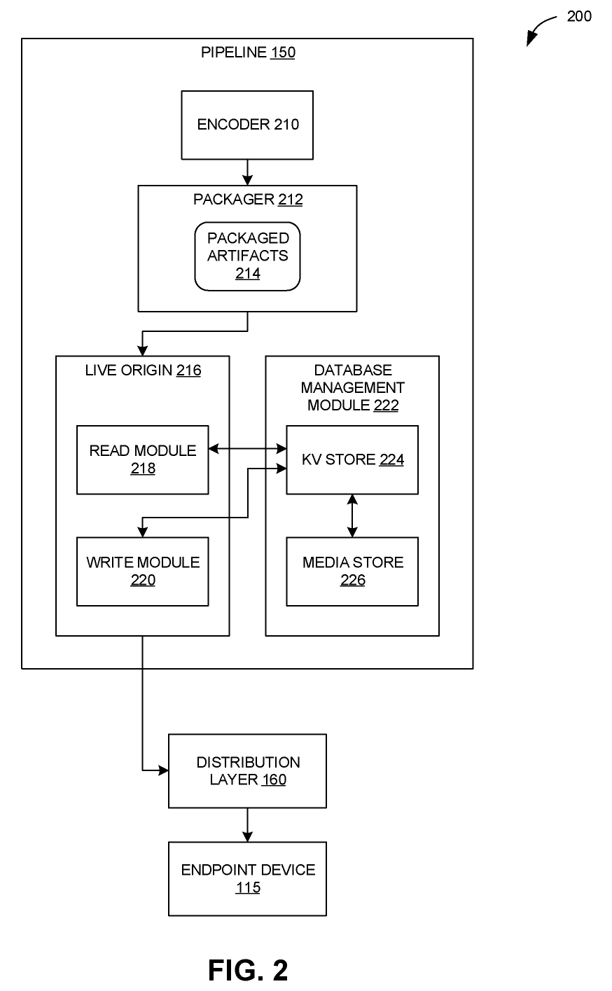

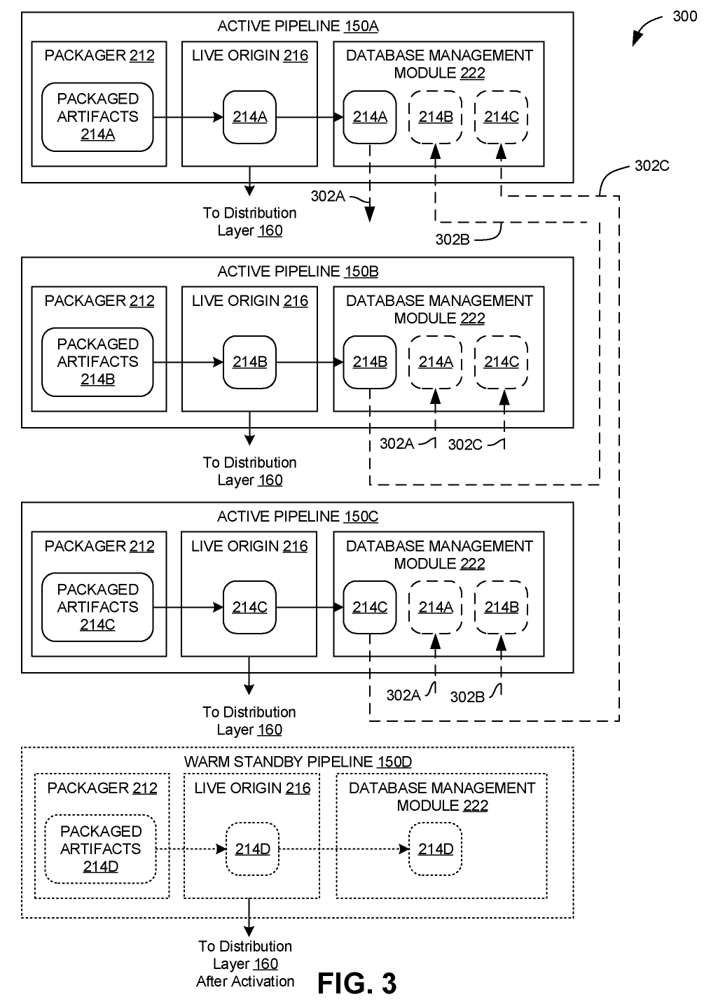

The pipelines 150 are configured to provide live content (e.g., livestream segments or media segments) such that the endpoint device 115 continues playback even if one of the pipelines 150 becomes unavailable. The pipelines 150 function as a processing path that prepares, processes, and outputs live content in a continuous manner. The continuity of playback across pipelines 150 is enabled by redundancy at both the region level and the distribution level. Further details are discussed in conjunction with FIGS. 2 and 3.

In some embodiments, the pipelines 150 are deployed proximately to a content source (e.g., the content servers 110), which can reduce ingest latency. The distribution layer 160 retrieves the packaged artifacts and delivers the packaged artifacts through the content servers 110 to endpoint devices 115. Area-wide distribution is delegated to a content distribution network (CDN), which can also reduce end-to-end latency.

The pipelines 150 receive a live contribution feed that includes livestream segments (herein also referred to as media segments), execute encoding, perform packaging operations, and publish packaged artifacts that include the livestream segment for distribution. Each pipeline 150 therefore includes functional components that execute the ingest, encode, package, and publish stages in sequence, discussed further in detail in conjunction with FIG. 2. The pipelines 150 generate packaged artifacts that are suitable for downstream caching by the content servers 110 and for playback retrieval by the endpoint devices 115. The specific components of the pipelines 150 are described in greater detail in conjunction with FIG. 2.

In some embodiments, the pipelines 150 are managed by the control server 120. The control server 120 determines the operational state of each of the pipelines 150, such as whether a given pipeline 150 is active, or whether a given pipeline 150 is in a warm standby state (discussed in further detail in conjunction with FIG. 3).

In some embodiments, the pipelines 150 produce multiple versions of live content to support adaptive streaming. Versions can include different bitrates, resolutions, and codec variants that are suitable for playback across the endpoint devices 115. The multiple versions allow client playback applications on endpoint devices 115 to select the appropriate live content based on network conditions and device capabilities.

In some embodiments, to enable switching between pipelines 150, discontinuity markers and synchronization signals are embedded within the packaged artifacts of the pipelines 150. The discontinuity markers signal a transition point where playback can switch from one of the pipelines 150 to another without introducing visible artifacts. The synchronization signals ensure that packaged artifacts generated by different pipelines 150 remain aligned at boundaries of the livestream segments. In this manner, endpoint devices 115 can receive live content from a new pipeline 150 during failures or transitions without playback interruption.

According to some embodiments, the pipelines 150 include a live origin – described in greater detail below in conjunction with FIG. 2 – that performs both publishing and retrieval operations for packaged artifacts. The live origin is the component within the pipeline 150 that evaluates the availability and quantity of packaged artifacts and determines whether to switch to a different pipeline 150 when content is not available or when content has a defect. In this manner, the live origin functions as the decision point for switching between pipelines 150. Because the live origin manages candidate selection and pipeline switching, pipelines 150 themselves remain simplified processing paths that execute encoding, packaging, and publishing without monitoring other pipelines. The live origin is discussed in greater detail in conjunction with FIG. 2.

In some embodiments, the pipelines 150 receive control signals from the control server 120 to enforce consistent behavior across a region. Each of the pipelines 150 is deployed within the associated region and publishes packaged artifacts associated with the region. Redundancy is achieved by deploying multiple pipelines 150 in multiple regions, enabling playback continuity if one of the regions becomes unavailable.

The distribution layer 160 provides the interface between pipelines 150 and endpoint devices 115. The distribution layer 160 ensures redundant delivery of packaged artifacts (e.g., live content) to client playback applications. The distribution layer 160 operates in a manner that abstracts which of the pipelines 150 generated a given packaged artifact, such that endpoint devices 115 receive continuous playback without awareness of a state of the pipeline 150.

In operation, the distribution layer 160 retrieves packaged artifacts from live origins. The distribution layer 160 transmits the packaged artifacts to content servers 110 and, in some embodiments, to CDNs for caching and delivery. For example, the distribution layer 160 can transmit the packaged artifacts to the content servers 110 for storage within a cache hierarchy or can push a set of packaged artifacts into an edge cache of a CDN for subsequent retrieval by the endpoint devices 115. In this manner, the distribution layer 160 ensures that packaged artifacts generated within pipelines 150 are propagated into caching infrastructures that serve endpoint devices 115.

In some embodiments, the distribution layer 160 delivers the packaged artifacts to endpoint devices 115 through content servers 110. Each content server 110 retrieves the packaged artifacts from the distribution layer 160 and responds to requests from endpoint devices 115.

In some embodiments, the distribution layer 160 is positioned between live origins and the content servers 110. In some embodiments, the distribution layer 160 operates according to policies defined by the control server 120. These policies can indicate (1) which live origin among the different live origins in the pipelines 150 is treated as the primary provider of packaged artifacts, (2) conditions under which the distribution layer 160 switches to a secondary live origin, and (3) that retrieval is performed according to a consistent global priority order of the pipelines 150 enforced by the live origin. The global priority order is discussed in greater detail in conjunction with FIG. 2. By enforcing these policies, the distribution layer 160 provides consistent and predictable delivery of packaged artifacts to the endpoint devices 115.

In some embodiments, the distribution layer 160 integrates with open connect CDNs and/or other cache infrastructures that distribute the packaged artifacts. Integration with open connect CDNs enables the packaged artifacts to be cached near the endpoint devices 115, reducing network latency.

FIG. 2 is a more detailed conceptual illustration of the pipeline 150 of FIG. 1, according to various embodiments. FIG. 2 includes, without limitation, a pipeline 150, a distribution layer 160, and an endpoint device 115. The pipeline 150 includes, without limitation, a packager 212, a live origin 216, and a database management module 222. The live origin 216 includes, without limitation, a read module 218 and a write module 220. The database management module 222 includes, without limitation, a key-value (KV) store 224 and a media store 226. The packager 212 generates packaged artifacts 214.

The components of the pipeline 150 execute an end-to-end workflow to generate live content, such as the packaged artifacts 214, that is distributed to the endpoint devices 115 through the distribution layer 160. Each of the pipelines 150 is deployed within a single region and operates independently of the other pipelines 150. The regional isolation of the pipelines 150 ensures that a failure in one region does not propagate to other regions.

The pipeline 150 executes ingestion of live feeds, encoding, packaging, publishing, and storage within a region-local boundary. Objects are carried end-to-end across the pipeline 150 through the following process. First, the encoder 210 receives live feeds and generates encoded media streams that represent the live feeds. The packager 212 transforms the encoded media streams into the packaged artifacts 214, which include media segments, manifests and/or playlists, and associated metadata. Metadata is included within the packaged artifacts 214 to define playback behavior, media segment structure, and synchronization information required by the endpoint devices 115. The packaged artifacts 214 are then stored by the live origin 216, and the write module 220 writes the packaged artifacts 214 into the database management module 222 for persistence and replication.

The encoder 210 performs encoding functions within the pipeline 150. In operation, the encoder 210 ingests live feeds that include video and audio streams. In some embodiments, the live feeds originate from a fill source 130, which transmits the live feeds into the pipeline 150. In other embodiments, the encoder 210 can ingest the live feeds from studio equipment, broadcast contribution networks, or satellite uplinks that provide raw video and audio content. The encoder 210 receives the uncompressed or lightly compressed live feeds and prepares the live feed for digital transmission.

The encoder 210 generates compressed encoded media streams from the live feeds. The encoded media streams can include compressed video encoded using formats such as H.264 or H.265, as well as compressed audio encoded using formats such as Advanced Audio Coding (AAC). The encoder 210 applies compression algorithms that reduce the data size of video and audio while preserving quality suitable for playback. The encoder 210 generates multiple encoded media streams at different bitrates and resolutions, which enables adaptive streaming by the endpoint devices 115. The encoded media streams generated by the encoder 210 are transmitted to the packager 212.

The packager 212 inputs the encoded media streams generated by the encoder 210. The packager 212 converts the encoded media streams into the packaged artifacts 214. The packager 212 performs packaging of the compressed video and audio streams in formats recognized by client playback applications and generates the packaged artifacts 214 by segmenting the encoded media segments and constructing manifests or playlists that describe the structure of the encoded media segments.

In various embodiments, segmentation of the encoded media streams into discrete segments can occur at different stages. In some embodiments, the encoder 210 performs the segmentation, which can include generating pre-segmented media streams that are provided to the packager 212. In other embodiments, the packager 212 performs the segmentation directly. The packager 212 can also apply digital rights management (DRM) protection to the segments by encrypting or encapsulating the packaged artifacts 214 in accordance with content protection policies recognized by client playback applications.

After packaging, the packager 212 implements a single-publish model. In the single-publish model, the packager 212 transmits packaged artifacts 214 once to the local live origin 216. In contrast, conventional approaches require the packager 212 to perform dual publishing. In the dual publishing technique, the packager 212 transmits the packaged artifacts 214 to both the local live origin 216 and the remote live origin 216 in different regions. With conventional techniques, as the number of regions increases, the packager 212 must perform publishing operations proportional to O(N²), which creates redundant copies of the same packaged artifacts 214 and imposes processing load on the packager 212. The single-publish model implemented by the packager 212 eliminates such dual publishing requirements by delegating cross-region propagation to the database management module 222, discussed in greater detail below.

When the packager 212 completes generation of the packaged artifacts 214, the packager 212 publishes the packaged artifacts 214 to the live origin 216. Publishing to the live origin 216 entails transmitting packaged artifacts 214 using protocols such as Hypertext Transfer Protocol (HTTP) PUT, HTTP POST, or secure file transfer mechanisms. In some embodiments, the packager 212 transmits the packaged artifacts 214 using chunked transfer encoding so that the live origin 216 can store and index each livestream segment as the livestream segment becomes available. In other embodiments, the packager 212 transmits entire playlists or manifests as discrete objects that the live origin 216 then writes into the media store 226.

The packaged artifacts 214 include, in some embodiments, HTTP Streaming (HLS) playlists, Dynamic Adaptive Streaming over HTTP (DASH) Media Presentation Descriptions (MPDs), and associated media segment files. In some embodiments, the packaged artifacts 214 include media segments. The media segments represent encoded video and audio content divided into smaller units for adaptive streaming. Media segments can include MP4 chunks, MPEG-2 Transport Stream (TS) segments, or Common Media Application Format (CMAF) segments. Each media segment contains compressed video frames and audio samples arranged in a time-aligned manner.

The packaged artifacts 214, in some embodiments, also include manifests or playlists that describe the structure and availability of the media segments. In some embodiments, manifests are generated as HTTP live streaming (HLS) playlists that list Uniform Resource Locators (URLs) for a sequence of TS segments or CMAF segments. In other embodiments, manifests are generated as DASH MPDs that describe media periods, adaptation sets, and segment templates. The manifests provide endpoint devices 115 with instructions for retrieving media segments in the correct order and for selecting among different bitrates and resolutions.

In addition, the packaged artifacts 214 include metadata required for playback management. Metadata can include timing data that specifies the start and end points of each media segment, keyframe positions that indicate valid switching points for playback transitions, and track information that describes codec type, resolution, and channel configuration. Metadata is used for synchronization across the pipelines 150 and for enabling switching during failover events of the pipeline 150.

The live origin 216 stores, manages, and serves the packaged artifacts 214 generated within the pipeline 150. The term “origin” refers to the source from which downstream distribution systems, such as the distribution layer 160 and content servers 110, retrieve media content. In the context of live streaming, the live origin 216 functions as the source for the packaged artifacts 214. The live origin 216 accepts the packaged artifacts 214 from the packager 212, persists the packaged artifacts 214 via the database management module 222, and makes the packaged artifacts 214 available for retrieval by playback applications.

The live origin 216 is region-aware, such that the live origin 216 can recognize both a local region in which the live origin 216 operates and the availability and quantity of packaged artifacts 214 across other remote regions. Unlike the encoder 210 and packager 212, which process local data, the live origin 216 can evaluate the state of data across multiple regions and select appropriate sources when local data (e.g., the packaged artifacts 214) are unavailable.

In conventional approaches, origins handle only local publishing and retrieval tasks without knowledge of other regions. Region awareness in the live origin 216 can be implemented in multiple ways. In some embodiments, the live origin 216 maintains configuration data identifying the available regions and the pipelines 150 deployed in each region. In other embodiments, the live origin 216 queries metadata in the database management module 222 to determine whether packaged artifacts 214 for a given segment are present in remote regions. In further embodiments, the live origin 216 exchanges health status signals with orchestration systems, allowing the live origin 216 to infer when a remote pipeline 150 has failed. By combining such mechanisms, the live origin 216 makes informed decisions about candidate selection and failover across regions.

The live origin 216 manages the interface between the pipeline 150 and downstream delivery systems such as the distribution layer 160 and the content servers 110. Notably, the pipelines 150 outside of the live origin 216 do not communicate with each other and are not aware of the availability of data in other regions. The live origin 216 alone determines whether to serve packaged artifacts 214 from the local region or to retrieve packaged artifacts 214 from another region.

The live origin 216 provides multi-region failover logic by detecting the presence and quality of the packaged artifacts 214 based on a global priority order that is uniform across different regions. The global priority order defines a ranked sequence of pipelines 150, where each pipeline 150 is associated with a respective region, and where the global priority order specifies the preferred source of the packaged artifacts 214 for the live origins 216. When a request for the packaged artifacts 214 is received by a live origin 216, the live origin 216 evaluates the region corresponding to the highest-ranked pipeline 150 in the global priority order. If the packaged artifacts 214 associated with the pipeline 150 are available and valid, then the live origin 216 retrieves the packaged artifacts 214 from the associated media store 226 of the pipeline 150. Otherwise, if the packaged artifacts 214 are unavailable or defective, then the live origin 216 advances to the next pipeline 150 in the global priority order, continuing the process until a valid pipeline 150 is located.

The global priority order is consulted by the live origin 216 each time a packaged artifact 214 request is processed. The global priority order is applied dynamically rather than relying on a fixed or cached source. In some embodiments, the global priority order is centrally configured and distributed through the control server 120 or a similar orchestration service. Any modification, such as adding, removing, or reprioritizing a pipeline 150, is automatically propagated across all live origins 216, maintaining uniformity of selection behavior across the distributed system.

In cases of prolonged outage, where a given pipeline 150 remains unavailable for an extended duration, the control server 120 or another orchestration layer can formally update the global priority order to demote or remove the failed pipeline 150 from the global priority order. The updated configuration is distributed to all live origins 216 so that subsequent selection operations deprioritize the failed pipeline 150.

In operation, the live origin 216 interfaces with the database management module 222 for both retrieval and persistence of the packaged artifacts 214 via the read module 218 and the write module 220, respectively. During playback retrieval, the live origin 216 utilizes the read module 218 to read the packaged artifacts 214 from the database management module 222. During publishing, the live origin 216 utilizes the write module 220 to transfer the packaged artifacts 214 from the packager 212 and writes the packaged artifacts 214 into the database management module 222.

When a pipeline 150 experiences a fault, such as a failure of the encoder 210 or loss of publishing from the packager 212, the live origin 216 of the pipeline 150 ceases to receive newly written packaged artifacts 214. Each live origin 216 continuously monitors the presence of the packaged artifacts 214 within the local media store 226 by querying for, in some embodiments, segment identifiers and/or timestamps included within the packaged artifacts 214 associated with active playback streams. If the live origin 216 detects that a newly expected packaged artifact 214 is absent or delayed beyond a defined threshold, the live origin 216 interprets a failure of the corresponding pipeline. Because this determination occurs at an individual packaged artifacts 214 level, the live origin 216 can make near-real-time decisions without waiting for a formal reconfiguration of the global priority order.

The read module 218 interfaces with the KV store 224 during playback retrieval for media segment-level candidate selection. When a request for the packaged artifacts 214 is received, the read module 218 queries the KV store 224 using keys that identify the requested media segment, manifest, or metadata. The read module 218 then receives the resolved query by the KV store 224 with the location of the packaged artifacts 214 in the media store 226. The read module 218 then retrieves the packaged artifact 214 based on the returned information.

The read module 218 executes a read path that begins with checking the media store 226 for the packaged artifacts 214 originating from a highest-ranked pipeline 150 according to the global priority order. If the packaged artifacts 214 are unavailable or invalid, then the read module 218 advances through the global priority order and selects the next available packaged artifacts 214.

The write module 220 manages persistence of the packaged artifacts 214 generated within the pipeline 150. In this context, writing refers to the process of writing the packaged artifacts 214 in the media store 226 for long-term persistence and cross-region replication.

Upon the live origin 216 receiving the packaged artifacts 214 from the packager 212, the write module 220 prepares the data for persistence via the database management module 222. The live origin 216, via the write module 220, validates the data, associates the packaged artifacts 214 with a namespace corresponding to the local region, and initiates the storage process.

The write module 220 forwards write operations into the database management module 222 by interfacing with the KV store 224 to establish the indexing required for persistence. In this context, indexing refers to the process of generating identifiers and metadata entries that allow the packaged artifacts 214 to be located and retrieved efficiently by the read module 218. When the write module 220 receives packaged artifacts 214 from the packager 212, the write module 220 inserts entries into the KV store 224 that define keys and values for each packaged artifact 214. The KV store 224 records identifiers such as segment numbers, track identifiers, and timing information, and associates the track identifiers with storage locations in the media store 226.

The database management module 222 is the storage and replication solution for the pipeline 150 associated with a given namespace. The database management module 222 is responsible for storing the packaged artifacts 214 published by the live origin 216, thereby ensuring that the packaged artifacts 214 become available across multiple regions. The database management module 222 consolidates the responsibility for propagation into a centralized layer rather than distributing the responsibility across multiple packagers 212.

The database management module 222 performs replication across regions asynchronously, offloading cross-region propagation from the packager 212. In some embodiments, the database management module 222 performs asynchronous, non-blocking replication of the packaged artifacts 214 across regions and into media stores 226 of remote pipelines 150 associated with other namespaces. Asynchronous replication means that when the packaged artifacts 214 are written into the database management module 222 in one region, the local write operation completes immediately without waiting for remote regions to confirm receipt. The packaged artifacts 214 are subsequently propagated in the background to remote regions and pipelines 150 associated with other namespaces. Such non-blocking behavior ensures that local publishing operations continue without delay while still guaranteeing that pipelines 150 in remote regions and associated with other namespaces eventually receive consistent copies of the packaged artifacts 214.

The database management module 222 is technology-agnostic and can be implemented using different types of distributed datastores. In some embodiments, the database management module 222 is implemented using Cassandra clusters configured for global replication. In other embodiments, the database management module 222 is implemented using dynamoDB global tables, which provide multi-region replication as a managed service. Additional embodiments can include EVCache augmented with custom replication logic or similar distributed storage technologies that support durability, scalability, and region-aware replication.

The database management module 222 includes the KV store 224, which provides an interface for the live origin 216 to perform both read and write operations. The KV store 224 functions as an application programming interface (API) and service layer that abstracts underlying infrastructure. When the write module 220 publishes packaged artifacts 214, the KV store 224 records key-value entries that associate identifiers, such as segment numbers or manifest identifiers, with storage locations in the media store 226. When the read module 218 requests packaged artifacts 214, the KV store 224 resolves the keys into storage locations and returns the associated values.

In some embodiments, the KV store 224 enforces namespace-based isolation on a per-pipeline 150 basis. Each pipeline 150 writes the packaged artifacts 214 into a distinct namespace, thereby ensuring that data generated by one pipeline 150 does not overwrite or conflict with data generated by another pipeline 150. The use of namespaces allows the live origin 216 to distinguish among different pipelines 150 while accessing the same shared database management module 222. In this context, a namespace refers to a storage space assigned within the database management module 222 for a particular pipeline 150, such that packaged artifacts 214 are written, indexed, and retrieved without colliding with packaged artifacts 214 associated with other pipelines 150.

The media store 226 stores the packaged artifacts 214 (e.g., media segments, manifests, and metadata) in a form suitable for long-term retention and retrieval. The media store 226 ensures that packaged artifacts 214 remain available for playback requests even if upstream components such as the encoder 210 or packager 212 become unavailable. Durability is achieved through replication of data across multiple nodes within the local region, which protects against hardware failures or localized outages.

Isolation of the media store 226 ensures that the failure of one region does not propagate to other regions. Each media store 226 operates independently within a given region and maintains a unique namespace for the packaged artifacts 214 generated by the packager 212 within the given pipeline 150. If the media store 226 in one region becomes unavailable due to failure, other media stores 226 in remote regions and/or pipelines 150 continue to function normally and provide access to replicated packaged artifacts 214.

The distribution layer 160 functions as the content delivery network layer that interfaces between the regional pipelines 150 and endpoint devices 115. In some embodiments, the distribution layer 160 includes open connect appliances (OCAs), which are cache servers within internet service provider networks. An OCA stores frequently requested packaged artifacts 214 close to the endpoint devices 115, which reduces latency and offloads traffic from upstream infrastructure. The distribution layer 160 can also include other content delivery networks that cache and deliver the packaged artifacts to the endpoint devices 115.

The distribution layer 160 fetches the packaged artifacts 214 from the live origins 216. The packaged artifacts 214 are written by the write module 220 into the database management module 222, and the distribution layer 160 interfaces with the live origin 216 to retrieve the packaged artifacts 214, as described in greater detail in conjunction with FIG. 3.

### Multi-Region Pipelines with Storage Propagation

FIG. 3 is an illustration of multiple pipelines 150 with storage propagation, according to various embodiments. As shown, FIG. 3 includes, without limitation, an active pipeline 150A, an active pipeline 150B, an active pipeline 150C, and a warm standby pipeline 150D. Each of the pipelines 150 includes a packager 212, a live origin 216, and a database management module 222. Further, FIG. 3 also includes dashed arrows 302A, 302B, and 302C, which represent propagation of packaged artifacts 214A, packaged artifacts 214B, and packaged artifacts 214C, respectively. Packaged artifacts 214D are associated with warm standby pipeline 150D, discussed in greater detail below.

Each active pipeline 150A-150C shows the flow of respective packaged artifacts 214A-214C as each active pipeline 150 operates independently.

The progression of the packaged artifacts 214 within the active pipelines 150 is shown with solid arrows. For example, the packaged artifacts 214A are generated by the packager 212 of active pipeline 150A and are published to the live origin 216 and subsequently written into the database management module 222 of the same pipeline 150A. The same sequence applies for packaged artifacts 214B in the active pipeline 150B and packaged artifacts 214C in the active pipeline 150C.

Cross-region propagation of packaged artifacts 214 is illustrated by the dashed arrows 302A, 302B, and 302C. For example, when packaged artifacts 214A are written into the database management module 222 of active pipeline 150A, replication processes asynchronously propagate the same packaged artifacts 214A to the database management modules 222 of all of the pipelines 150, regardless of whether such pipelines 150 are in an active state or a warm standby state. As described herein, each pipeline 150 can be associated with a particular namespace. Accordingly, references to propagation or replication across pipelines 150A-C should be understood to include propagation across respective namespaces.

In each of the active pipelines 150A-150C, the packager 212 receives an encoded media stream. The packager 212 consumes the encoded media stream and generates packaged artifacts 214. In the active pipeline 150A, the packager 212 generates packaged artifacts 214A, in the active pipeline 150B, the packager 212 generates the packaged artifacts 214B, and in the active pipeline 150C, the packager 212 generates the packaged artifacts 214C.

The live origin 216 then accepts the packaged artifacts 214 from the packager 212 and coordinates both persistence and subsequent delivery. In particular, the live origin 216 issues write commands to the database management module 222 to ensure that packaged artifacts 214 are stored.

Within the live origin 216, a write module 220 (not pictured) transmits the packaged artifacts 214 to the local database management module 222 for persistence. For example, when the packager 212 of pipeline 150A generates packaged artifacts 214A, the live origin 216 passes the artifacts into the write module 220. The write module 220 records the artifacts via the KV store 224 within the local media store 226 of the active pipeline 150A. As a specific example, the packaged artifacts 214A may be associated with a unique key in the KV store 224 that points to a storage location in the media store 226. In a similar manner, packaged artifacts 214B and packaged artifacts 214C are processed by the respective live origins 216. Once indexed via the KV store 224, the packaged artifacts 214 are persisted in the media store 226 of the database management module 222.

After arriving in the respective media stores 226, cross-pipeline replication is executed. Cross-pipeline behavior is represented by the dashed arrows 302A, 302B, and 302C in FIG. 3. When the media store 226 of the active pipeline 150A receives the packaged artifacts 214A, the database management module 222 automatically propagates the packaged artifacts 214A to the media stores 226 of the pipelines 150. This process is indicated by dashed arrow 302A. Replication of the packaged artifacts 214B from the active pipeline 150B to the active pipelines 150A and 150C is shown by the dashed arrow 302B. Replication of packaged artifacts 214C from the active pipeline 150C to the active pipelines 150A and 150B is shown by the dashed arrow 302C. For clarity of illustration, the complete length of 302A is omitted, but the entry and exit points of the replication paths are shown. Replication is asynchronous and non-blocking. In some embodiments, when the pipeline 150 writes the packaged artifacts 214 to the local media store 226, the write operation is considered complete immediately without waiting for confirmation that the packaged artifacts 214 have reached remote regions. Background processes then propagate the artifacts to the remote media stores 226.

The database management module 222 then ensures that every media store 226 across regions contains copies of the packaged artifacts 214A, 214B, and 214C generated by the active pipelines 150. After each of the live origins 216 contains the local packaged artifacts 214 and the propagated packaged artifacts 214 for a given media segment, the live origins 216 distribute the packaged artifacts 214 via the distribution layer 160 when the packaged artifacts 214 are requested. The distribution layer 160 transmits the packaged artifacts 214 from live origins 216 to the endpoint devices 115 for the active pipelines 150 only. The warm standby pipeline 150D transmits to the distribution layer only after activation, which is discussed in detail below. The distribution layer 160 fetches packaged artifacts via the live origins 216. The packaged artifacts 214 retrieved from the live origins 216 are then delivered as candidate-selected outputs to the endpoint devices 115 for playback.

The operation of the distribution layer 160 follows a sequence of steps. The distribution layer 160 first receives a request from the endpoint device 115, in some embodiments through the content server 110 or directly, for a manifest or a media segment. The distribution layer 160 then forwards the request to the live origin 216 that serves as the source for the requested media segment.

The live origin 216 then applies the global priority order for the active pipelines 150. The live origin 216, through the read module 218, then identifies the requested packaged artifacts 214 within the media store 226 based on the global priority order. The read module 218 determines the media segment time requested by the endpoint device 115 and attempts retrieval in accordance with the priority sequence. The read module 218 then checks the database management module 222 to locate the packaged artifacts 214 within the namespace corresponding to the selected active pipeline 150. If the segment is not present, the read module 218 advances to the next candidate pipeline in the global priority order until the media segment is located or a failure is signaled.

Once the requested packaged artifact 214 is identified, the live origin 216 retrieves the packaged artifact 214 from the media store 226 and returns the packaged artifact 214 to the distribution layer 160. In some embodiments, the distribution layer 160 then caches the packaged artifacts 214. The distribution layer 160 then delivers the packaged artifact 214 to the content servers 110 or directly to the endpoint device 115. In some embodiments, delivery is executed using HTTP-based protocols. For example, a manifest may be cached in an open connect appliance and served to the endpoint devices 115, while time-aligned media segments may be provided over standard HTTP range requests.

The distribution layer 160 and the live origin 216 repeat the process for each subsequent media segment requested during playback. If the active pipeline 150 fails and the warm standby pipeline 150D becomes active. When the warm standby pipeline 150D generates segments, and if active, the read module 218 incorporates the warm standby pipeline 150D into the candidate sequence, thereby enabling uninterrupted playback despite failures of pipelines 150.

### Warm Standby Pipeline

The warm standby pipelines (e.g., warm standby pipeline 150D) provide redundancy without contributing an active load during normal operation. The warm standby pipelines are reserved for failover scenarios in which one of the active pipelines 150A-150C becomes unavailable.

In some embodiments, in a warm standby state, a warm standby pipeline 150 does not ingest encoder input until explicitly triggered. Further, the packager 212 and the live origin 216 remain dormant. No packaged artifacts 214 are generated, persisted, or replicated when operating in the warm standby state. By avoiding ingestion of live input, operating in the warm standby state reduces the risk of failures that could be caused by problematic input streams. The warm standby state is particularly useful in minimizing processing load or protecting standby resources from unstable encoder inputs. Upon activation, the warm standby pipeline 150 operating in the warm standby state begins ingestion from the encoder 210, and begins generating the packaged artifacts 214. In some embodiments, when operating in the warm standby state, no packaged artifacts 214 are generated by the warm standby pipeline 150.

Activation of the warm standby pipeline 150D can be triggered when a failure is detected in one of the active pipelines 150A-150C. Failure detection is handled by the live origin 216 in conjunction with the database management module 222. In some embodiments, the live origin 216 monitors the availability of the packaged artifacts 214 at segment-level granularity. If the media segments expected from the pipeline 150 are absent, or if the encoder 210 consistently fails to deliver input, the live origin 216 determines that the pipeline has failed. Upon detection, in some embodiments the control server 120, another management system, or the live origin 216 issues a command to activate the warm standby pipeline 150D. Once activated, the warm standby pipeline 150D begins outputting packaged artifacts 214 in the same manner as an active pipeline.

### Method Diagrams

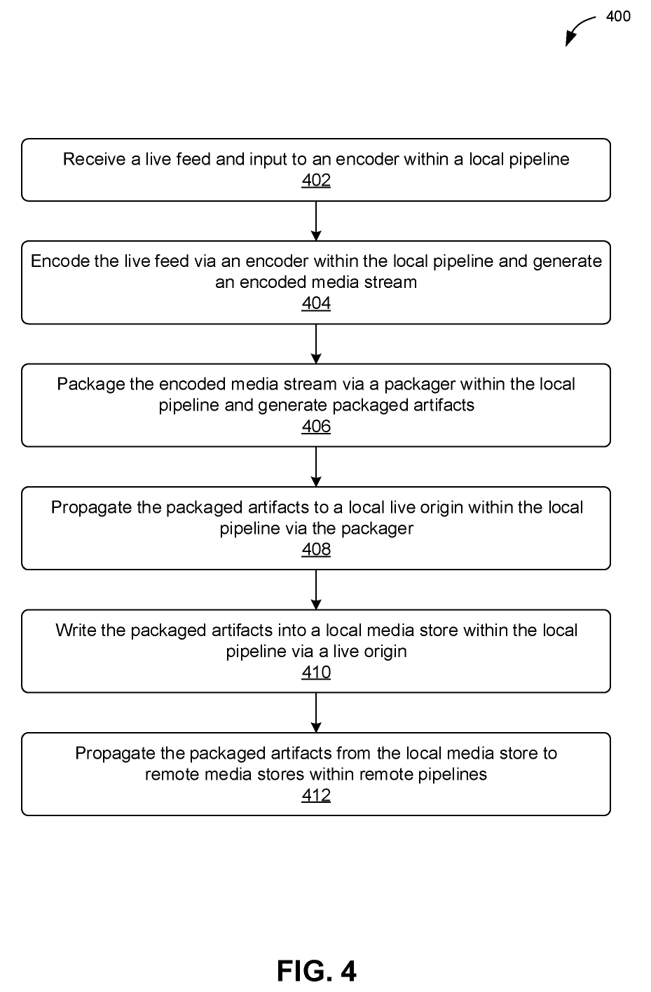

FIG. 4 illustrates a flow diagram of a method 400 for generation and distribution of packaged artifacts 214 within a pipeline 150, according to various embodiments. Although the method steps are described in conjunction with the systems of FIGS. 1-3, persons skilled in the art will understand that any system configured to perform the method steps, in any order, is within the scope of the present disclosure.

As shown in FIG. 4, the method 400 begins at step 402, where a local pipeline 150 receives a live feed. The live feed can include live video, live audio, or both, provided from a capture device, a broadcast feed, and/or a fill source 130.

At step 404, an encoder 210 within the local pipeline 150 encodes the live feed to generate an encoded media stream. The encoding process applies compression techniques such as H.264 or H.265 for video and AAC or Dolby Digital for audio. The process generates the encoded media stream at one or more bitrates and resolutions. The encoded media stream preserves synchronization between video and audio and is then transmitted to a packager 212.

At step 406, the packager 212 packages the encoded media stream and generates packaged artifacts 214. The packaged artifacts 214 include segment files (such as MP4 fragments, MPEG-TS segments, or CMAF segments), manifests or playlists (such as HLS playlists or DASH MPDs), and associated metadata including timing data, keyframe positions, and track information.

At step 408, the packager 212 propagates the packaged artifacts 214 to a local live origin 216 within the same local pipeline 150. The live origin 216 receives the packaged artifacts 214.

At step 410, the live origin 216 writes the packaged artifacts 214 into a local media store 226. The live origin 216, via a write module 220, interfaces with a KV store 224 included within a database management module 222 to execute a write operation. In some embodiments, the write operation includes recording index entries in a KV store 224 and persisting the packaged artifacts in the media store 226.

At step 412, the database management module 222 propagates the packaged artifacts 214 from the local media store 226 to remote media stores 226 within remote pipelines 150. In some embodiments, the propagation is asynchronous and non-blocking. Each remote media store 226 receives a complete copy of the packaged artifacts 214, thereby creating redundancies.

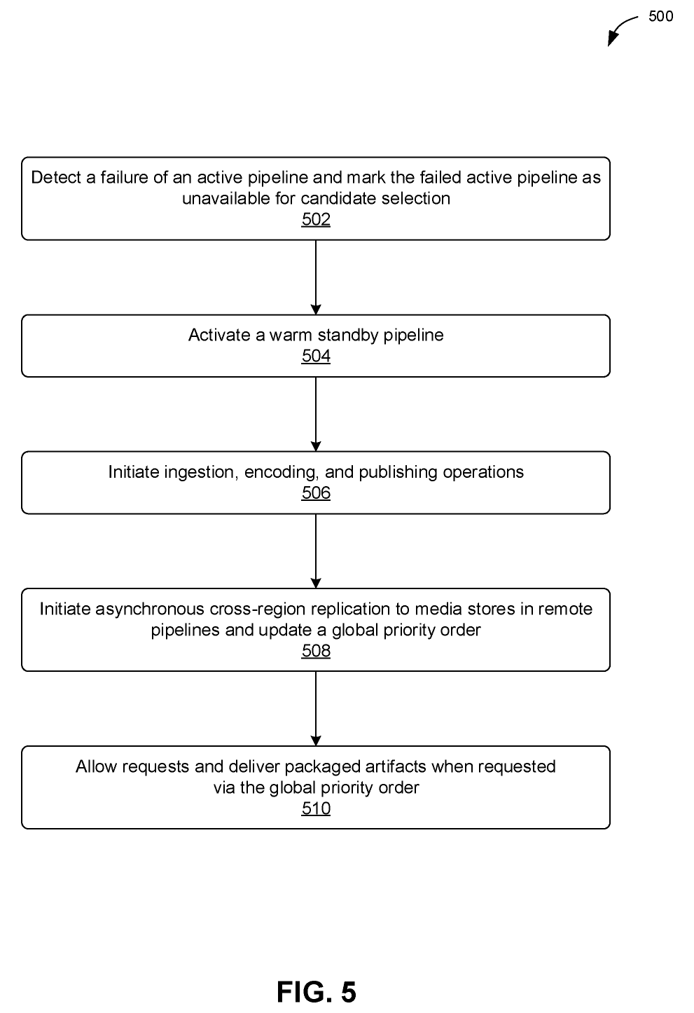

FIG. 5 illustrates a flow diagram of a method 500 for activation and subsequent delivery of packaged artifacts 214 in a warm standby pipeline 150, according to various embodiments. Although the method steps are described in conjunction with the systems of FIGS. 1-3, persons skilled in the art will understand that any system configured to perform the method steps, in any order, is within the scope of the present disclosure.

As shown in FIG. 5, the method 500 begins at step 502, where a live origin 216 detects a failure of an active pipeline 150 and marks the failed active pipeline 150 as unavailable for candidate selection. In some embodiments, detection of the failure can involve monitoring the absence of packaged artifacts 214 at the live origin 216, identifying repeated write errors in the database management module 222, or receiving a control signal from the control server 120. As the global priority order is preconfigured, the failed pipeline 150 is automatically handled at a retrieval attempt as the failed pipeline 150 does not generate content.

At step 504, the live origin 216 of a warm standby pipeline 150 activates the warm standby pipeline 150. In some embodiments, the activation can be triggered by the control server 120. Activation enables the warm standby pipeline 150 to begin a transition to an operational state.

At step 506, the warm standby pipeline 150 initiates ingestion, encoding, and publishing operations. The encoder 210 begins receiving input and generates encoded streams that are provided to the packager 212. The packager 212 processes the encoded streams into the packaged artifacts 214 and transmits the packaged artifacts 214 to the live origin 216. The live origin 216 writes the packaged artifacts 214 to the media store 226. The live origin 216 exposes the packaged artifacts 214 for delivery through the distribution layer 160. The warm standby pipeline 150 becomes an active standby pipeline 150.

At step 508, the database module 222 initiates asynchronous cross-region replication of the packaged artifacts 214 to media stores 226 in remote pipelines 150. Such replication ensures that packaged artifacts 214 from the active standby pipeline 150 become globally available and contribute to redundancy across pipelines 150. In some embodiments, a global priority order is updated to allow the candidate selection process executed by the read module 218 of remote live origins 216 to incorporate the active standby pipeline as a source of packaged artifacts 214. This ensures that subsequent requests for segments and manifests consider the active standby pipeline alongside existing active pipelines.

At step 510, the active standby pipeline 150 allows requests for packaged artifacts 214 and delivers the packaged artifacts 214 in response to client or content servers 110 requests according to the global priority order. The read module 218 applies the candidate selection process in accordance with the global priority order. In this manner, the active standby pipeline 150 participates in content delivery.

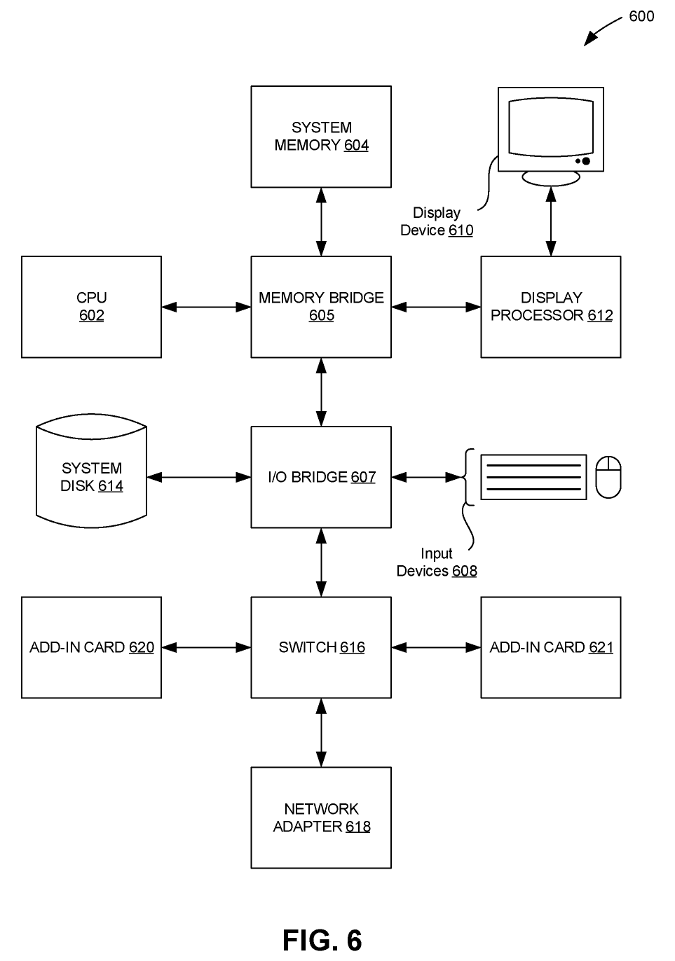

FIG. 6 is a more detailed illustration of a computing device that can implement the functionalities of any of the entities illustrated in FIG. 1, according to various embodiments. This figure in no way limits or is intended to limit the scope of the various embodiments. In various implementations, system 600 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 600 may be coupled together to practice one or more aspects of the various embodiments.

As shown, system 600 includes a central processing unit (CPU) 602 and a system memory 604 communicating via a bus path that may include a memory bridge 605. CPU 602 includes one or more processing cores, and, in operation, CPU 602 is the master processor of system 600, controlling and coordinating operations of other system components. System memory 604 stores software applications and data for use by CPU 602. CPU 602 runs software applications and optionally an operating system. Memory bridge 605, which may be, e.g., a Northbridge chip, is connected via a bus or other communication path (e.g., a HyperTransport link) to an I/O (input/output) bridge 607. I/O bridge 607, which may be, e.g., a Southbridge chip, receives user input from one or more user input devices 608 (e.g., keyboard, mouse, joystick, digitizer tablets, touch pads, touch screens, still or video cameras, motion sensors, and/or microphones) and forwards the input to CPU 602 via memory bridge 605.

A display processor 612 is coupled to memory bridge 605 via a bus or other communication path (e.g., a PCI Express, Accelerated Graphics Port, or HyperTransport link); in one embodiment display processor 612 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 612 periodically delivers pixels to a display device 610 (e.g., a screen or conventional CRT, plasma, OLED, SED or LCD based monitor or television). Additionally, display processor 612 may output pixels to film recorders adapted to reproduce computer generated images on photographic film. Display processor 612 can provide display device 610 with an analog or digital signal. In various embodiments, one or more of the various graphical user interfaces set forth in FIG. 3 are displayed to one or more users via display device 610, and the one or more users can input data into and receive visual output from those various graphical user interfaces.

A system disk 614 is also connected to I/O bridge 607 and may be configured to store content and applications and data for use by CPU 602 and display processor 612. System disk 614 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 616 provides connections between I/O bridge 607 and other components such as a network adapter 618 and various add-in cards 620 and 621. Network adapter 618 allows system 600 to communicate with other systems via an electronic communications network, and may include wired or wireless communication over local area networks and wide area networks such as the Internet.

Other components (not shown), including USB or other port connections, film recording devices, and the like, may also be connected to I/O bridge 607. For example, an audio processor may be used to generate analog or digital audio output from instructions and/or data provided by CPU 602, system memory 604, or system disk 614. Communication paths interconnecting the various components in FIG. 6 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 612 incorporates circuitry optimized for graphics and video processing, including, for example, video output circuitry, and constitutes a graphics processing unit (GPU). In another embodiment, display processor 612 incorporates circuitry optimized for general purpose processing. In yet another embodiment, display processor 612 may be integrated with one or more other system elements, such as the memory bridge 605, CPU 602, and I/O bridge 607 to form a system on chip (SoC). In still further embodiments, display processor 612 is omitted and software executed by CPU 602 performs the functions of display processor 612.

Pixel data can be provided to display processor 612 directly from CPU 602. In some embodiments, instructions and/or data representing a scene are provided to a render farm or a set of server computers, each similar to system 600, via network adapter 618 or system disk 614. The render farm generates one or more rendered images of the scene using the provided instructions and/or data. These rendered images may be stored on computer-readable media in a digital format and optionally returned to system 600 for display. Similarly, stereo image pairs processed by display processor 612 may be output to other systems for display, stored in system disk 614, or stored on computer-readable media in a digital format.

Alternatively, CPU 602 provides display processor 612 with data and/or instructions defining the desired output images, from which display processor 612 generates the pixel data of one or more output images, including characterizing and/or adjusting the offset between stereo image pairs. The data and/or instructions defining the desired output images can be stored in system memory 604 or graphics memory within display processor 612. In an embodiment, display processor 612 includes 3D rendering capabilities for generating pixel data for output images from instructions and data defining the geometry, lighting shading, texturing, motion, and/or camera parameters for a scene. Display processor 612 can further include one or more programmable execution units capable of executing shader programs, tone mapping programs, and the like.

Further, in other embodiments, CPU 602 or display processor 612 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 602, display processor 612, or one or more other processing devices or any combination of these different processors.

CPU 602, render farm, and/or display processor 612 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 600 may be a robot or robotic device and may include CPU 602 and/or other processing units or devices and system memory 604. In such embodiments, system 600 may or may not include other elements shown in FIG. 6. System memory 604 and/or other memory units or devices in system 600 may include instructions that, when executed, cause the robot or robotic device represented by system 600 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 604 is connected to CPU 602 directly rather than through a bridge, and other devices communicate with system memory 604 via memory bridge 605 and CPU 602. In other alternative topologies display processor 612 is connected to I/O bridge 607 or directly to CPU 602, rather than to memory bridge 605. In still other embodiments, I/O bridge 607 and memory bridge 605 might be integrated into a single chip. The particular components shown herein are optional; for instance, any number of add-in cards or peripheral devices might be supported. In some embodiments, switch 616 is eliminated, and network adapter 618 and add-in cards 620, 621 connect directly to I/O bridge 607.

In sum, techniques are disclosed for implementing live streaming pipelines that operate within a given region. The pipelines include an encoder, a packager, a live origin, and a datastore. The encoder generates live video streams, and the packager transforms such live video streams into packaged artifacts. The packager transmits the packaged artifacts once to the live origin associated with the pipeline of the packager. The live origin holds the packaged artifacts and coordinates with the datastore for replication operations to other regions. The datastore executes asynchronous propagation of the packaged artifacts across pipelines. The live origin performs the selection of the pipeline for playback based on a global priority order. The global priority order identifies a designated pipeline for primary playback retrieval. If the designated pipeline does not provide packaged artifacts – or, if the packaged artifacts possess defects for a requested livestream segment – then the live origin retrieves the packaged artifacts from an alternate pipeline identified by the global priority order. Candidate selection occurs on a per-segment basis, which enables playback continuity when a failure or delay occurs in the given pipeline.

The disclosed techniques also introduce a warm standby pipeline that can be maintained in a warm standby state within a given region. In the warm standby state, the warm standby pipeline does not generate packaged artifacts. The warm standby pipeline achieves recovery by publishing packaged artifacts when activated from a warm standby state, thereby replacing a failed pipeline without requiring reinitialization of the entire pipeline sequence.

At least one technical advantage of the disclosed techniques relative to the prior art is that the disclosed techniques reduce publishing complexity of the packager from O(N²) to O(N). Linear scalability of the packager facilitates implementation of the live streaming platform across multiple regions without imposing quadratic growth in publishing from the packager. Such features therefore improve overall platform scalability capabilities.

Another technical advantage of the disclosed techniques over the prior art is that the disclosed techniques eliminate overlapping redundancy and reduce computational strain on the packagers. In particular, by avoiding replication of packaged artifacts by the packager, the disclosed techniques prevent unnecessary generation of duplicate copies across the pipelines. Reduced duplication improves storage utilization by reducing redundant storage. Additionally, reduced publishing operations improve processing efficiency of the packager by minimizing the number of publishing tasks that the packager must execute. Such optimization frees system resources and increases system reliability during live streaming operations.

1. In some embodiments, a computer-implemented method for streaming media content to endpoint devices comprises: asynchronously replicating a plurality of packaged artifacts among a plurality of pipelines such that, for each pipeline included in the plurality of pipelines, a corresponding local datastore stores both locally generated packaged artifacts and remotely generated packaged artifacts; and in response to receiving a request from an endpoint device for a packaged artifact included in the plurality of packaged artifacts: selecting, according to a global priority order, a candidate pipeline from among the plurality of pipelines; retrieving, from a local datastore, the packaged artifact associated with the candidate pipeline; and providing the packaged artifact to the endpoint device.

2. The computer-implemented method of clause 1, wherein asynchronously replicating the plurality of packaged artifacts comprises performing non-blocking replication that completes a local write operation without waiting for confirmation from remote pipelines.

3. The computer-implemented method of any of clauses 1-2, wherein asynchronously replicating the plurality of packaged artifacts comprises propagating the plurality of packaged artifacts across a plurality of geographical regions.

4. The computer-implemented method of any of clauses 1-3, wherein each local datastore maintains per-pipeline namespaces that separately index locally generated packaged artifacts and remotely generated packaged artifacts.

5. The computer-implemented method of any of clauses 1-4, wherein each namespace is associated with a pipeline identifier that identifies a source pipeline for each packaged artifact.

6. The computer-implemented method of any of clauses 1-5, wherein the global priority order is centrally configured and distributed to the plurality of pipelines by a control server.

7. The computer-implemented method of any of clauses 1-6, further comprising updating the global priority order in response to detecting that at least one pipeline included in the plurality of pipelines is unavailable.

8. The computer-implemented method of any of clauses 1-7, wherein selecting the candidate pipeline according to the global priority order is performed independently for each requested media segment of a livestream.

9. The computer-implemented method of any of clauses 1-8, wherein retrieving the packaged artifact from the local datastore comprises accessing a key-value store that maps identifiers of the plurality of packaged artifacts to storage locations in a media store.

10. The computer-implemented method of any of clauses 1-9, further comprising embedding discontinuity markers and synchronization signals in the plurality of packaged artifacts to enable switching between pipelines without playback interruption.

11. In some embodiments, one or more non-transitory computer readable media store instructions that, when executed by one or more processors, cause the one or more processors to stream media content to endpoint devices, by performing the operations of: asynchronously replicating a plurality of packaged artifacts among a plurality of pipelines such that, for each pipeline included in the plurality of pipelines, a corresponding local datastore stores both locally generated packaged artifacts and remotely generated packaged artifacts; and in response to receiving a request from an endpoint device for a packaged artifact included in the plurality of packaged artifacts: selecting, according to a global priority order, a candidate pipeline from among the plurality of pipelines; retrieving, from a local datastore, the packaged artifact associated with the candidate pipeline; and providing the packaged artifact to the endpoint device.

12. The one or more non-transitory computer readable media of clause 11, wherein the packaged artifacts include at least one of HTTP Live Streaming playlists, Dynamic Adaptive Streaming over HTTP media presentation descriptions, or time-aligned media segments.

13. The one or more non-transitory computer readable media of any of clauses 11-12, further comprising activating a warm standby pipeline in response to a failure of another pipeline.

14. The one or more non-transitory computer readable media of any of clauses 11-13, wherein activating the warm standby pipeline comprises transitioning the warm standby pipeline from a warm standby state in which packaged artifacts are not generated to an active state in which the packaged artifacts are published and asynchronously replicated to other pipelines.

15. The one or more non-transitory computer readable media of any of clauses 11-14, wherein asynchronously replicating the plurality of packaged artifacts comprises performing non-blocking replication that completes a local write operation without waiting for confirmation from remote pipelines.

16. The one or more non-transitory computer readable media of any of clauses 11-15, wherein asynchronously replicating the plurality of packaged artifacts comprises propagating the plurality of packaged artifacts across a plurality of geographical regions.

17. The one or more non-transitory computer readable media of any of clauses 11-16, wherein each local datastore maintains per-pipeline namespaces that separately index locally generated packaged artifacts and remotely generated packaged artifacts.

18. The one or more non-transitory computer readable media of any of clauses 11-17, wherein each namespace is associated with a pipeline identifier that identifies a source pipeline for each packaged artifact.

19. The one or more non-transitory computer readable media of any of clauses 11-18, wherein the global priority order is centrally configured and distributed to the plurality of pipelines by a control server.

20. In some embodiments, a computer system comprises one or more memories that include instructions, and one or more processors that are coupled to the one or more memories and that, when executing the instructions, are configured to stream media content to endpoint devices, by performing the operations of: asynchronously replicating a plurality of packaged artifacts among a plurality of pipelines such that, for each pipeline included in the plurality of pipelines, a corresponding local datastore stores both locally generated packaged artifacts and remotely generated packaged artifacts, and in response to receiving a request from an endpoint device for a packaged artifact included in the plurality of packaged artifacts: selecting, according to a global priority order, a candidate pipeline from among the plurality of pipelines; retrieving, from a local datastore, the packaged artifact associated with the candidate pipeline, and providing the packaged artifact to the endpoint device.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for streaming media content to endpoint devices, the method comprising:
asynchronously replicating a plurality of packaged artifacts among a plurality of pipelines such that, for each pipeline included in the plurality of pipelines, a corresponding local datastore stores both locally generated packaged artifacts and remotely generated packaged artifacts; and
in response to receiving a request from an endpoint device for a packaged artifact included in the plurality of packaged artifacts:
selecting, according to a global priority order, a candidate pipeline from among the plurality of pipelines;
retrieving, from a local datastore, the packaged artifact associated with the candidate pipeline; and
providing the packaged artifact to the endpoint device.

2. The computer-implemented method of claim 1, wherein asynchronously replicating the plurality of packaged artifacts comprises performing non-blocking replication that completes a local write operation without waiting for confirmation from remote pipelines.

3. The computer-implemented method of claim 1, wherein asynchronously replicating the plurality of packaged artifacts comprises propagating the plurality of packaged artifacts across a plurality of geographical regions.

4. The computer-implemented method of claim 1, wherein each local datastore maintains per-pipeline namespaces that separately index locally generated packaged artifacts and remotely generated packaged artifacts.

5. The computer-implemented method of claim 4, wherein each namespace is associated with a pipeline identifier that identifies a source pipeline for each packaged artifact.

6. The computer-implemented method of claim 1, wherein the global priority order is centrally configured and distributed to the plurality of pipelines by a control server.

7. The computer-implemented method of claim 6, further comprising updating the global priority order in response to detecting that at least one pipeline included in the plurality of pipelines is unavailable.

8. The computer-implemented method of claim 1, wherein selecting the candidate pipeline according to the global priority order is performed independently for each requested media segment of a livestream.

9. The computer-implemented method of claim 1, wherein retrieving the packaged artifact from the local datastore comprises accessing a key-value store that maps identifiers of the plurality of packaged artifacts to storage locations in a media store.

10. The computer-implemented method of claim 1, further comprising embedding discontinuity markers and synchronization signals in the plurality of packaged artifacts to enable switching between pipelines without playback interruption.

11. One or more non-transitory computer readable media storing instructions that, when executed by one or more processors, cause the one or more processors to stream media content to endpoint devices, by performing the operations of:
asynchronously replicating a plurality of packaged artifacts among a plurality of pipelines such that, for each pipeline included in the plurality of pipelines, a corresponding local datastore stores both locally generated packaged artifacts and remotely generated packaged artifacts; and
in response to receiving a request from an endpoint device for a packaged artifact included in the plurality of packaged artifacts:
selecting, according to a global priority order, a candidate pipeline from among the plurality of pipelines;
retrieving, from a local datastore, the packaged artifact associated with the candidate pipeline; and
providing the packaged artifact to the endpoint device.

12. The one or more non-transitory computer readable media of claim 11, wherein the packaged artifacts include at least one of HTTP Live Streaming playlists, Dynamic Adaptive Streaming over HTTP media presentation descriptions, or time-aligned media segments.

13. The one or more non-transitory computer readable media of claim 11, further comprising activating a warm standby pipeline in response to a failure of another pipeline.

14. The one or more non-transitory computer readable media of claim 13, wherein activating the warm standby pipeline comprises transitioning the warm standby pipeline from a warm standby state in which packaged artifacts are not generated to an active state in which the packaged artifacts are published and asynchronously replicated to other pipelines.

15. The one or more non-transitory computer readable media of claim 11, wherein asynchronously replicating the plurality of packaged artifacts comprises performing non-blocking replication that completes a local write operation without waiting for confirmation from remote pipelines.

16. The one or more non-transitory computer readable media of claim 11, wherein asynchronously replicating the plurality of packaged artifacts comprises propagating the plurality of packaged artifacts across a plurality of geographical regions.

17. The one or more non-transitory computer readable media of claim 11, wherein each local datastore maintains per-pipeline namespaces that separately index locally generated packaged artifacts and remotely generated packaged artifacts.

18. The one or more non-transitory computer readable media of claim 17, wherein each namespace is associated with a pipeline identifier that identifies a source pipeline for each packaged artifact.

19. The one or more non-transitory computer readable media of claim 11, wherein the global priority order is centrally configured and distributed to the plurality of pipelines by a control server.

20. A computer system, comprising:
one or more memories that include instructions; and
one or more processors that are coupled to the one or more memories and, when executing the instructions, are configured to stream media content to endpoint devices, by performing the operations of:
asynchronously replicating a plurality of packaged artifacts among a plurality of pipelines such that, for each pipeline included in the plurality of pipelines, a corresponding local datastore stores both locally generated packaged artifacts and remotely generated packaged artifacts; and
in response to receiving a request from an endpoint device for a packaged artifact included in the plurality of packaged artifacts:
selecting, according to a global priority order, a candidate pipeline from among the plurality of pipelines;
retrieving, from a local datastore, the packaged artifact associated with the candidate pipeline; and
providing the packaged artifact to the endpoint device.
